(19) United States
(12) Patent Application Publication
(10) Pub. No.: US 2006/0219626 A1
(43) Pub. Date: Oct. 5, 2006

(54) Filter system with canister filter element

(75) Inventors: Klemens Dworatzek, Edingen (DE); Ralf Bauder, Ketsch (DE); Karlheinz Muenkel, Oberderdingen-Flehingen (DE); Duc Cuong Nguyen, Laatzen (DE)

Correspondence Address: CROWELL & MORING LLP;INTELLECTUAL PROPERTY GROUP, P.O. BOX 14300, WASHINGTON, DC, 20044-4300, US

(73) Assignee: MANN & HUMMEL GMBH, Ludwigsburg (DE)

(21) Appl. No.: 11/354,168

(22) Filed: Feb. 15, 2006

Related U.S. Application Data
(60) Provisional application No. 60/666,189, filed on Mar. 30, 2005.

(30) Foreign Application Priority Data
Feb. 15, 2006 (DE) 10 2005 007 019.1

(51) Int. Cl. B01D 35/28

(52) U.S. Cl. 210/443; 210/450; 210/455

(57) ABSTRACT

A filter system for a fluid, particularly a liquid filter, especially an oil filter for an internal combustion engine, having a receiving head, a cup-shaped housing releasably connectable to the receiving head, and a replaceable filter element disposed the cup-shaped housing, in which the filter element has a liquid-tight casing which is received in the interior of the cup-shaped housing.

### BACKGROUND OF THE INVENTION

The present invention relates to a fluid filter, particularly a liquid filter, especially an oil filter for an internal combustion engine, comprising a receiving head, a cup-shaped housing releasably connectable to the receiving head, and a replaceable filter element disposed in the cup-shaped housing.

Two major types of fluid filters, particularly oil filters for internal combustion engines, are known in the art. The first major type comprises so-called spin-on filters. A spin-on filter has a cup-shaped housing, a filter element non-releasably disposed therein, and a threaded end plate. The cup-shaped housing is made of metal, so that it can withstand the pressure pulsation which occurs in the interior of the filter during operation of the internal combustion engine. The spin-on filter is screwed onto a receiving flange, or directly onto the engine block of the internal combustion engine, and during servicing is completely replaced with a new spin-on filter. This has drawbacks, however, resulting from the material mix of the filter because a mixture of plastics, paper, and metal must be disposed of, and material separation for disposal is problematic.

The second major filter type comprises so-called oil modules in which a filter element is releasably disposed in a preferably cup-shaped housing and with the aid of this housing is likewise screwed onto a receiving head located within the oil circuit. For servicing, only the metal-free filter cartridge needs to be replaced, while the cup-shaped housing is a lifetime component.

German Utility Model No. DE 200 04 31 U1 discloses a liquid filter with a bypass valve. A hollow cylindrical filter element is releasably disposed within a cup-shaped housing, and the cup-shaped housing is screwed onto a connection head. A support tube, which receives the bypass valve, is disposed concentrically within the interior of the filter element. The drawback of this arrangement lies in the changing of the filter element. First, there is a risk of contamination of the direct surroundings of the oil filter element because the oil-soaked filter medium still contains a residual amount of oil, which may drip as the filter element is replaced. In addition, the hands of the service personnel may become soiled because they come into direct contact with the oil-soaked filter element.

### SUMMARY OF THE INVENTION

Accordingly, it is the object of the present invention to provide an improved fluid filter, especially one which is suitable for internal combustion engine applications.

Another object of the invention is to provide a fluid filter that can be disposed of without requiring separation of different materials.

A further object of the invention is to provide a fluid filter which is simple and clean to use.

It is also an object of the invention to provide a fluid filter which offers protection against pressure pulsations.

These and other objects are achieved in accordance with the present invention by providing a filter system for filtering a fluid comprising a receiving head, a cup-shaped housing releasably connectable to said receiving head, and a replaceable filter element disposed in said housing, in which the filter element is provided with a liquid-tight casing which is received in the interior of the cup-shaped housing.

The fluid filter system according to the invention, particularly a liquid filter, especially an oil filter for an internal combustion engine, has a cup-shaped housing, a replaceable filter element disposed therein, and a receiving head, such that the cup-shaped housing is releasably connectable to the receiving head. The filter element further has a liquid-tight casing within the cup-shaped housing. The liquid-tight casing is preferably made of a plastic material, which may be blow molded or injection molded. The exterior shape resembles the interior shape of the cup-shaped housing, i.e., here too, a cup shape is preferred. This shape may be designed to fully contact the cup-shaped housing, contact it only at a few points, or not contact it at all, but the distance between the inner wall of the cup-shaped housing and the outer wall of the liquid-tight casing should be as small as possible. This has the positive effect that when the filter element is replaced, the liquid present within the filter element cannot escape, and contamination of the environment is prevented. Soiling of the hands of the service personnel is also avoided because the outer shell of the liquid-tight casing is dry and clean. A further advantage compared to the conventional oil modules is that soiling of the inner wall of the cup-shaped housing is also avoided because the inner wall of the cup-shaped housing does not come into contact with the circulating oil.

In accordance with one advantageous embodiment of the invention, the cup-shaped housing is capable of absorbing and counteracting operational diameter fluctuations of the liquid-tight casing. These operational diameter fluctuations may, for example, comprise a diameter increase as a result of temperature fluctuations. By matching the liquid-tight casing to the cup-shaped housing it is possible to produce the liquid-tight casing with a thin wall thickness and to use an inexpensive plastic, so that the manufacture of the filter element becomes more cost-effective, and the desired functions can nevertheless be fulfilled. The cup-shaped housing, on the other hand, can be made more robust using a metal or plastic, so that it can absorb the diameter increase of the liquid-tight casing. The liquid-tight casing is supported against the robust cup-shaped housing, which as a lifetime component can have a greater wall thickness than the liquid-tight casing.

It is advantageous if the filter element comprises at least one hollow cylindrical filter bellows, which sealingly separates a liquid inlet from a liquid outlet. To this end, the liquid-tight casing includes a support for the radial outer contour of the filter bellows. The filter bellows may be constructed from a zigzag folded or wound filter medium, which may be made of filter paper or a synthetic nonwoven material. Because of the pressure pulsation during operation there is a risk that the filter bellows will collapse under certain circumstances. To counteract this, many hollow cylindrical filter elements have a support member within their interior diameter, but this does not eliminate the risk of an outward collapse. With this configuration, a radial expansion of the filter bellows as a result of pressure pulsations can be absorbed by the support within the liquid-tight casing. In combination with the absorption of the diameter fluctuations of the liquid-tight casing by the cup-shaped housing, the forces that occur can be transmitted directly to the cup-shaped housing via the liquid-tight casing. The result is a combination of ease of maintenance through clean servicing of the filter element, integration of the function of an external support member for the filter bellows, and cost-effective design of the liquid-tight casing because certain functions influencing stability can be assumed by the cup-shaped housing.

It is advantageous if the outer support is constructed as circumferentially distributed support contours in the liquid-tight casing. On the one hand, the support contours support the outer contour of the filter bellows against radially outwardly acting forces and, on the other hand, the support contours transmit the absorbed forces to the cup-shaped housing.

In accordance with another embodiment of the invention, the support contours form discharge volumes between the filter bellows and the inside of the liquid-tight casing, such that the discharge volumes communicate with the floor of the liquid-tight casing. As a result, the liquid cleaned by the filter bellows can flow through the discharge volumes to the floor of the liquid-tight casing. Apart from these advantages, i.e., greater ease of maintenance and the function of an external support member, a third advantage is achieved, i.e., the possibility of using the support member to receive and transfer a liquid.

In accordance with yet another advantageous embodiment of the invention, the liquid-tight casing has at least one active contour in the region of one of the end faces, extending radially beyond the circumferential diameter. This active contour enables, for example, a precise radial and axial association or positioning relative to the cup-shaped housing. The active contour also makes it possible to check whether a filter element is inserted and whether the inserted filter element is suitable for the filter system.

Advantageously, the active contour is designed to communicate with a recess in the cup-shaped housing. Because no liquid is present outside the filter element, the filter element can be easily inserted into the cup-shaped housing and axially and radially fixed without a special seal being required.

According to another advantageous embodiment of the inventive concept, an integral anti-drain membrane or back-flow check membrane is disposed in the region of the liquid inlet and outlet. This integral anti-drain membrane functions as a normal anti-drain membrane in the inlet region and, in addition, as an anti-drain valve in the outlet region. During operation of the internal combustion engine the inlet and outlet are open if the filter element is inserted. If the filter element is removed, however, the integral anti-drain membrane prevents the content of the filter element from flowing out of the inlet and/or outlet. This again has a substantial advantage during servicing because the filter element can be removed from the cup-shaped housing and disposed of at an angle to the horizontal without any leakage of the liquid contents which remain in the filter element.

According to yet another embodiment of the invention, two hollow cylindrical filter bellows are arranged concentrically within the interior of the liquid-tight casing. The filter bellows have a common end disk on one end face, and each bellows has a separate end disk on the other end face. The end disk is preferably made of a thermoplastic material, and the filter bellows are connected to the end disk by adhesive bonding or fusion welding. The common end disk is preferably annular in shape, so that a flow-through opening for the filtered liquid is formed concentrically in the interior of the inner filter bellows. The separate configuration of the two end disks on the opposite end face of the two filter bellows makes it possible to realize filter bellows having differing axial lengths.

It is advantageous if the common end disk has spring member on the side opposite the filter bellows to support the filter bellows against the inside of the floor of the liquid-tight casing. This makes it possible to axially support and fix the filter bellows relative to the liquid-tight casing.

According to yet another advantageous embodiment of the invention, the separate end disk of the outer filter bellows simultaneously forms a tight seal for the liquid-tight casing, so that the radially outer rim of the end disk is tightly and non-releasably connected to the liquid-tight casing. This connection may, for example, be provided by welding, bonding or some other conventional process for permanently connecting two plastic parts.

In addition, the separate end disk may advantageously have an annular collar that extends axially away from the filter element. A seal member to seal the filter element relative to the connection head is disposed within the annular collar. This seal member may, for example, be an O-ring or a sealing ring, which is disposed in a groove formed in the outer or inner circumference of the annular collar. Thus, the end disk of the outer filter bellows on the one hand secures the filter element and on the other hand seals the filter element and provides a connection to a connection head.

The liquid is filtered as follows. The unfiltered liquid flows through at least one inlet into a gap between the two filter bellows. To filter the liquid, it then passes through the two filter bellows—radially inwardly on the one hand and radially outwardly on the other. The filtered portion of the liquid stream that flowed inwardly into the interior of the inner filter bellows then flows back into the liquid circuit through the outlet. The filtered portion of the liquid that flowed radially outwardly into the outer filter bellows is conducted to the floor of the liquid-tight casing by the active contours of the liquid-tight casing, from where it flows through the opening in the separate end disk to reach the interior of the inner filter bellows. From there it is likewise transferred back into the liquid system through the outlet.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawing figures, in which:

FIG. 1 is a sectional view of a liquid filter according to the invention;

FIG. 2 is a sectional view of the filter element and the cup-shaped housing;

FIG. 3 is a perspective view of the filter element and the cup-shaped housing;

FIG. 4 is a separate perspective view of the cup-shaped housing;

FIG. 5 is a sectional view of an outer shell of a filter element according to the invention;

FIG. 6 is a perspective view of the anti-drain membrane;

FIG. 7 is a top view of a section in the region of the blocking member;

FIG. 8 is a sectional view of an alternative anti-drain membrane, and

FIG. 9 is a sectional view of a portion of an alternative filter element.

### DETAILED DESCRIPTION OF PREFERRED EMBODIMENTS

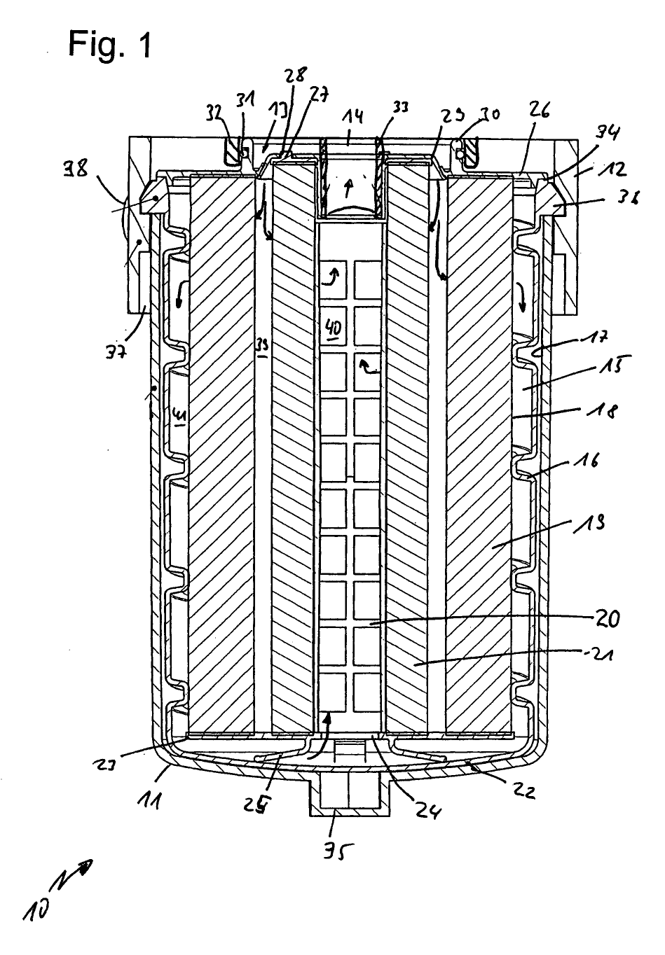

FIG. 1 is a sectional view of a liquid filter system 10 in which a cup-shaped housing 11 is connected to a connection head by a bayonet connection. The connection head 12 may be a separate connecting flange, or it may be formed directly from an internal combustion engine component. The filter system is suitable for liquids of any kind used in an internal combustion engine, such as oils, fuels, hydraulic fluids, or coolants. An inlet 13 and an outlet 14 are disposed in the connection head 12 of the filter system 10. The outlet 14 is arranged concentrically in the center of the connection between the cup-shaped housing 11 and the connection head 12. The inlet 13 is distributed concentrically around the outlet 14, also in the interior of the connection between the cup-shaped housing 11 and the connection head 12.

Inside the cup-shaped housing 11 is a filter element 15. The filter element 15 comprises a canister 16 which holds the filter medium or media. The circumference of the canister 16 is radially outwardly supported against an inside wall 17 of the cup-shaped housing 11. At the same time the canister supports an outer wall 18 of a first filter bellows 19 via grooves formed in the canister 16. The canister 16 is liquid-tight and additionally functions as an outer support tube for the first filter bellows 19 and a support against pressure pulsations at the cup-shaped housing 11. As a result, the canister 16 can be constructed relatively thin with regard to its material thickness because the actual support against each pressure pulsation is provided by the cup-shaped housing 11.

Disposed concentrically within the interior of the filter element is a support tube 20 around which extends a second filter bellows 21. The first and second filter bellows may be a zigzag folded filter medium, a wound filter medium, a combination thereof, or some other conventional filter bellows. In the region of a housing floor 22 of the canister 16, the two filter bellows are held by an end disk 23, which is ring-shaped with a concentrically disposed opening 24. A spring element 25 is integrally formed on the end disk 23. Spring element 25 supports the filter bellows against the housing floor 22 and axially locates and fixes the filter bellows by applying an axial spring force in an upward direction. Radial location and fixation is achieved by the inner contour of the canister 16.

At the opposite end of the filter bellows, the first filter bellows 19 has an end disk seal 26. The second filter bellows 21, which is disposed in the interior of the first filter bellows 19, extends slightly higher in the axial direction than the first filter bellows 19. The end face seal of the second filter bellows 21 is provided by an end disk 27, which is annular in shape and has a concentric passage for the outlet 14. The end disk 27 has a coupling contour 28 extending axially toward the connection head 12 for an anti-drain membrane 29. This coupling contour 28 is distributed across the end disk 27 and comprises a plurality of pins or mushroom-shaped contours protruding axially toward the connection head 12. The anti-drain membrane 29 is tightly coupled to the end disk 27 by the coupling contour 28. It seals the liquid inlet 13 when the internal combustion engine is stopped and the liquid outlet 14 during servicing. The anti-drain membrane 29 is preferably made of a soft thermoplastic material, such as a thermoplastic elastomer (TPE).

The end disk 26 comprises a concentric, axially protruding annular collar 30 with a groove in its outer circumference to accommodate a sealing ring 31. When the cup-shaped housing 11 is connected to the connection head 12, the annular collar 30 is inserted into a collar seat 32 of the connection head, so that the sealing ring 31 provides a seal between the annular collar 30 and the collar seat 32. Disposed concentrically in the interior of the collar seat 32 is an outlet tube 33, which extends into the opening of the end disk 27 and thereby opens the anti-drain element of the anti-drain membrane 29 on the outlet side. To seal the unfiltered side from the filtered side, sealing is effected radially between the anti-drain membrane 29 and the outlet tube 33, which is disposed in the connection head 12. To seal the filter element 15 liquid tight, the canister 16 and the end disk 26 are non-releasably and sealingly interconnected by a connecting contour 34, e.g., by fusion welding or adhesive bonding.

To release the filter element for servicing and to connect it, the cup-shaped housing 11 has a tool-holding fixture 35 having, for example, a hexagon socket or a hexagon head. For servicing, a tool is applied at this point to separate the cup-shaped housing 11 from the connection head 12, or to reconnect the two parts. The plurality of circumferentially spaced locking element parts 36 in the form of a radially outwardly protruding lug is shaped from the one axial end of the canister 16. These parts engage in recesses of the cup-shaped housing and recesses within a locking contour of the cup-shaped housing 11, which will be described with reference to the following figures. The part 36 of the locking elements of the canister 16 simultaneously serves as a connecting contour 34 relative to the end disk 26. The connection head 12 has guides 37 into which locking contours formed from the part 36 of the locking elements of the canister 16 and from the cup-shaped housing 11 can be inserted and in which they are guided.

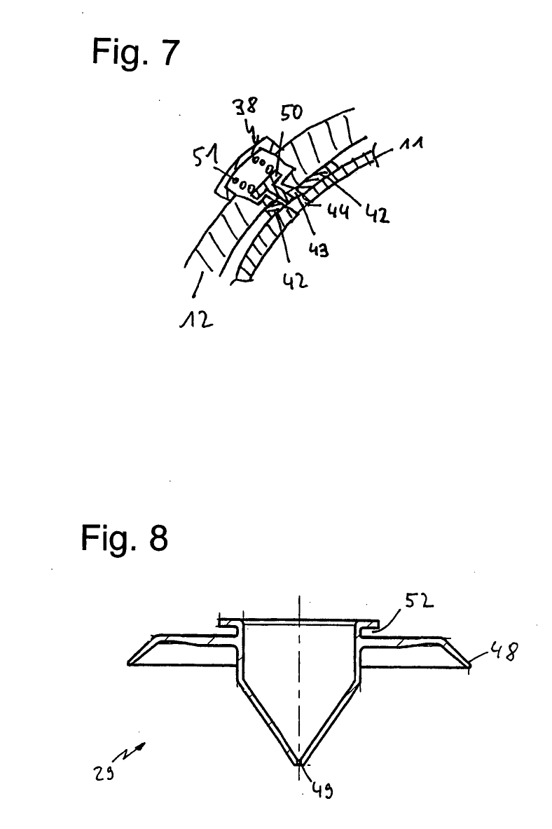

Disposed in the outer region of the connection head 12 is at least one blocking member 38, which prevents a connection between the cup-shaped housing and the connection head 12 when no filter element 15 or a wrong filter element is inserted. The blocking member 38 then engages in a recess 44 of the cup-shaped housing 11 and thereby prevents the bayonet connection from closing. The function of the blocking member 38 is illustrated in FIG. 7.

The liquid to be filtered flows through the inlet 13 of the connection head 12 into a space 39 between the two filter bellows 19, 21, then flows through the second or inner filter bellows 21 into a discharge chamber 40 located on the filtered side within the support tube 20. From the discharge chamber 40 the filtered liquid flows back into the system through the anti-drain membrane 29, which is opened by the outlet tube 33, and through the outlet 14 located on the filtered side. Another portion of the unfiltered liquid flows radially outwardly from the space 39 through the first or outer filter bellows 19 into a space on the canister side, from whence it flows downwardly to the canister floor 22. From the canister floor the liquid can again be returned to the system through the outlet 14 on the filtered side.

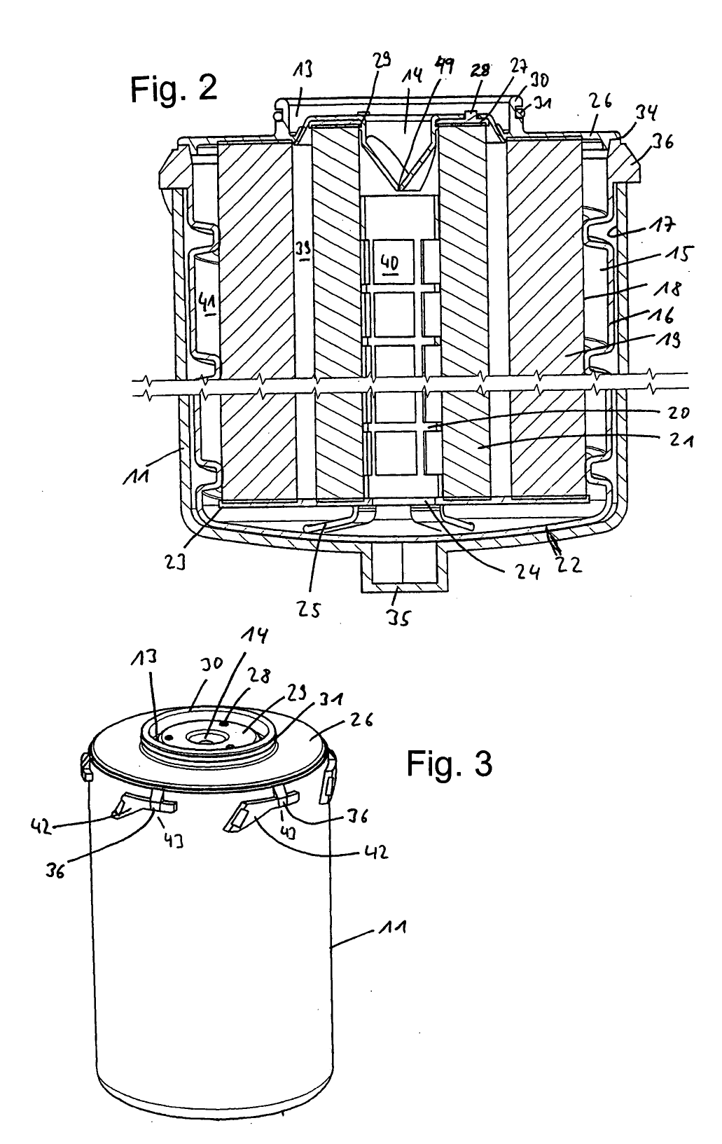

FIG. 2 illustrates the combination of the filter element 15 and the cup-shaped housing 11 in a sectional view. Components corresponding to those depicted in FIG. 1 are identified by the same reference numerals. FIG. 2 shows that when the cup-shaped housing 11 and the filter element 15 are released from the connection head 12, the anti-drain membrane 29 returns to its original shape in the region of the outlet 14 on the filtered side because the outlet tube 33 is no longer present, so that the anti-drain membrane prevents the liquid stored in the filter element 15 from leaking out. Since the anti-drain membrane 29 is made of a thermoplastic elastomer, the contour can generate a return force within the blocking membrane, which return force has the effect of producing a tightly closed seal at the outlet.

FIG. 3 is a perspective view of the cup-shaped housing 11 and the filter element 15 disposed therein. Parts corresponding to those depicted in the previous figures are identified by the same reference numerals. This figure clearly shows the plurality of coupling contours 28 of the end disk 27 for the anti-drain membrane 29. The open axial end of the cup-shaped housing 11 further has a plurality of regularly spaced locking contours 42 around the circumference to produce the bayonet connection within the filter system 10.

When the filter element 15 is correctly installed, the locking element part 36 on the filter element side is disposed in a recess 43 of the locking contour 42 to complete the locking contour 42. If the filter element 15 is not inserted, or if the filter element does not match, the recess 43 within the locking contour 42 remains free, so that the blocking member 38 prevents a bayonet-type connection between the cup-shaped housing 11 and the connection head 12. The blocking member 38 then engages in the recess 43 and prevents the cup-shaped housing 11 from being twisted relative to the connection head 12.

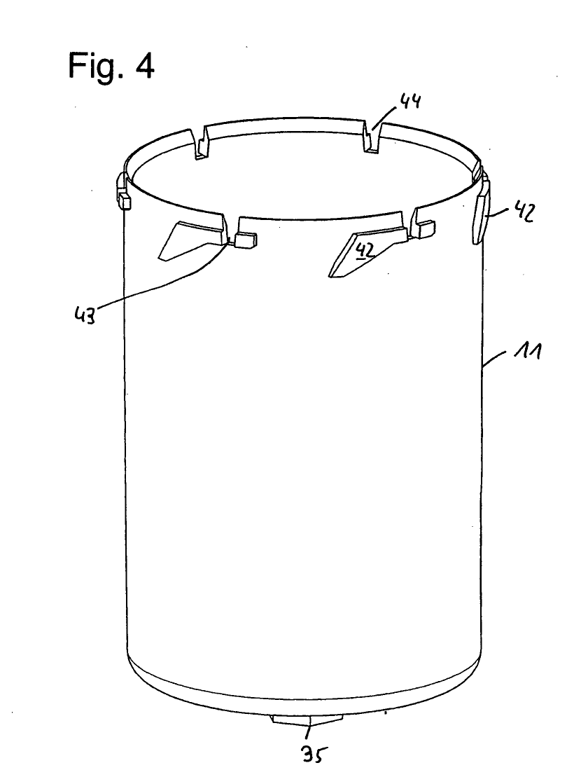

FIG. 4 shows a perspective view of the cup-shaped housing 11. To insert the filter element 15, the cup-shaped housing 11 has circumferentially spaced recesses 44 extending axially from the open end of the cup-shaped housing 11 and ending in the recesses 43 for the locking contour. The filter element 15 with the parts 36 of the locking elements is inserted into the recesses 44 until it reaches the end of the recess 43 of the locking contour so as to complete the locking contour 42. Only this completes the locking contours 42 to establish the connection to the connection head 12.

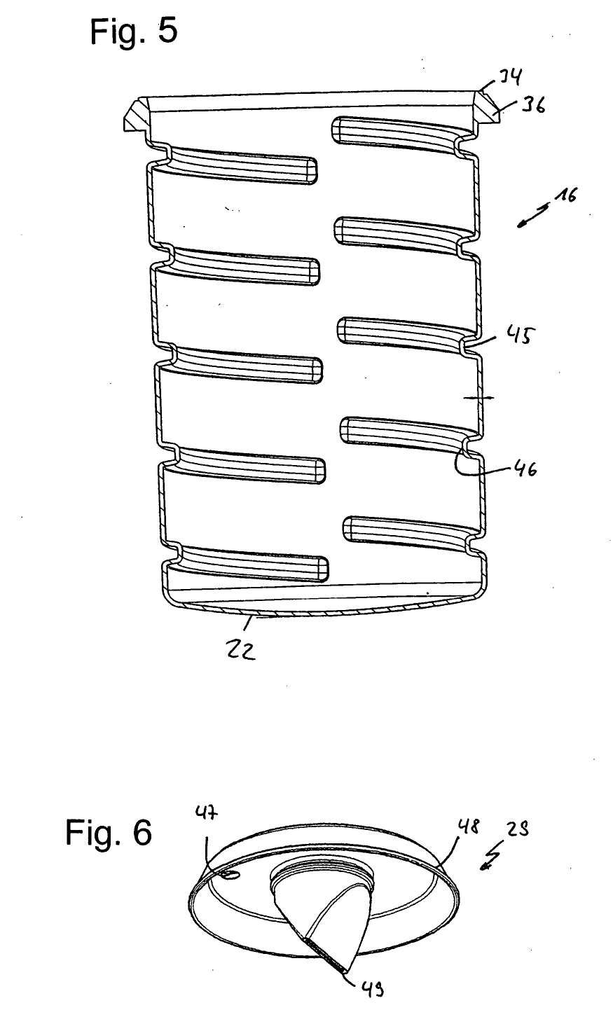

FIG. 5 is a sectional view of the canister 16, which represents the outer shell of the filter element 15. A plurality of grooves 45 are distributed across the lateral face of the canister 16 and form a support face 46 within the interior of the canister 16 for the first filter bellows 19. Because the grooves, 45 in the inner circumference of the canister 16 are not continuous, the filtered liquid flowing through the first filter bellows 19 can be easily fed to the discharge space 40 on the filtered side via the canister floor 22.

The rest of the above-described filter element is then inserted into the canister 16 and is connected to the canister 16 at the connecting contour 34. This creates a liquid-tight system that prevents contamination of the surroundings and the environment and eliminates the handling of dirty filters by the maintenance personnel during servicing. The axial seal of the canister 16 in the region of the open end is again formed by the locking element part 36, which engages in the recess .43 of the locking contour 42 of the cup-shaped housing 11.

FIG. 6 is a perspective view of the anti-drain membrane 29. Components corresponding to those shown in the preceding figures are again identified by the same reference numerals. The anti-drain membrane 29 is substantially plate-shaped and is preferably made from a thermoplastic elastomer. Anti-drain membrane 29 has a plurality of openings 47 in the plate-shaped part to create the coupling with the end disk 27 via the coupling contour 28. In its outer region, the anti-drain membrane 29 has a sealing face 48 angled relative to the plate-shaped region for the inlet area of the filter system 10. Because of the flexibility of the material, the inlet area lifts from a sealing face in the end disk seal 26 as the liquid to be filtered streams in and thereby ensures the inflow of the liquid. When the internal combustion engine is stopped, i.e., when there is no liquid pressure against the anti-drain membrane, the sealing face 48 seals the inlet 13 because of its elasticity.

Concentrically disposed in the interior of the anti-drain membrane 29 is a type of sealing valve 49 to seal the outlet when the filter element is removed from the liquid circuit. The outlet seal 49 has a kind of duckbill, which in the inserted state is opened from the connection head 12 by the outlet tube 33 and which closes again because of its inherent elasticity when the outlet tube 33 is removed. Here, the anti-drain membrane and the anti-drain valve are integrated in a single component.

FIG. 7 illustrates one possibility of using the blocking member 38. Once again, parts corresponding to those shown in the previous figures are identified by the same reference numerals. FIG. 7 shows a top view of a cutaway section in the area of the blocking member 38. The blocking member 38 is disposed in the connection head 12. A locking pin 50 and a spring member 51 are disposed in the connection head 12 such that the locking pin 50 is axially displaceable against the force of the spring member 51.

When the cup-shaped housing 11 and the locking head 12 are brought together and no filter element 15 is present or provided, the force of the spring 51 causes the locking pin 50 to engage in the recess of the locking contour 43, thereby preventing the twisting necessary to create the bayonet connection. If the filter element 15 is inserted correctly, the recesses 43 and 44 are filled by the locking element part 36 of the filter element 15 and thereby complete the locking contour 42. As a result, the locking pin 50 is pushed into the locking head 12 against the force of the spring member 51, so that the cup-shaped housing 11 can be twisted relative to the connection head 12, allowing the bayonet connection to be created.

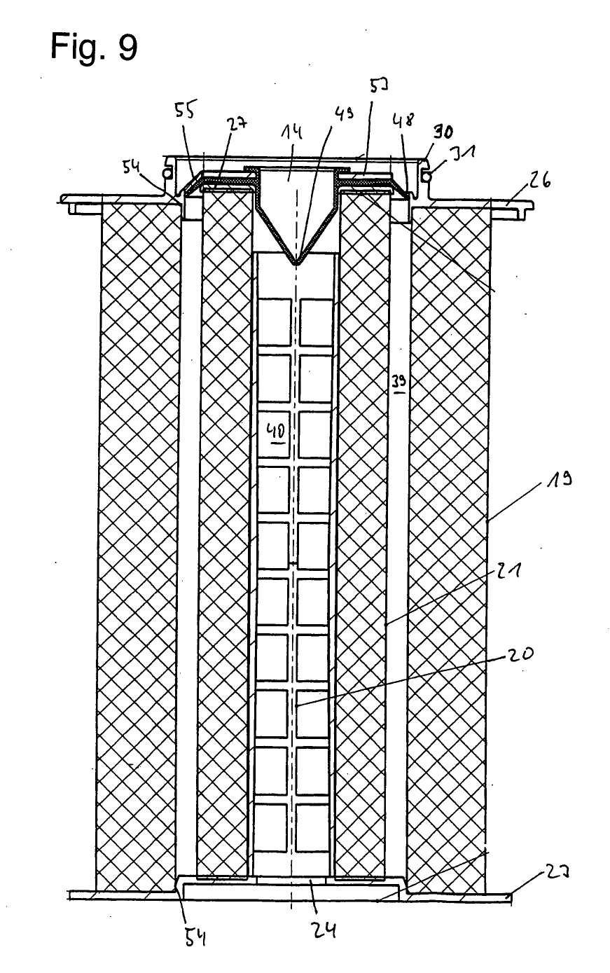

FIG. 8 shows a sectional view of an alternative anti-drain membrane 29. Again, pars corresponding to those shown in the preceding figures are identified by the same reference numerals. In this embodiment, the connection to the filter element is realized in an alternative manner through a circumferential annular groove 52 disposed concentrically to the inlet sealing face 48. This annular groove receives an end disk (not shown). This connection is discussed further below with reference to FIG. 9.

FIG. 9 shows a sectional view of a portion of an alternative filter element using the anti-drain membrane 29. Again, parts corresponding to those shown in the preceding figures are identified by the same reference numerals. In this case, the inner filter bellows 21 is sealingly connected by hot plate welding to the lower end disk 23 and the upper end disk 27. A securing ring 53 holding the anti-drain membrane 29 is concentrically disposed within the end disk seal 26. The securing ring 53 is preferably integrally connected to the end disk seal 26 via connecting webs 55, such that the connecting webs 55 are circumferentially disposed around the outlet 14. The end disk seal 26 and the end disk 23 each have sealing faces 54 for the outer filter bellows 19 and in addition fix the outer filter bellows. The canister 16 (not shown) may be configured analogously to the preceding embodiments and thus connects the two end disks 23 and 26.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A filter system for filtering a fluid, said filter system comprising a receiving head, a cup-shaped housing releasably connectable to said receiving head, and a replaceable filter element disposed in said housing, wherein the filter element is provided with a liquid-tight casing which is received in the interior of the cup-shaped housing.

2. A filter system according to claim 1, wherein said filter is a liquid filter.

3. A filter system according to claim 2, wherein said filter is an oil filter for lubricating oil of an internal combustion engine.

4. A filter system according to claim 1, wherein the liquid-tight casing has substantially the same outer contour as the inner contour of the cup-shaped housing, such that the cup-shaped housing can absorb and counteract operational diameter fluctuations of the liquid-tight casing.

5. A filter element for a filter system comprising a receiving head and a cup-shaped housing releasably connectable to said receiving head for receiving the filter element therein, said filter element comprising a liquid-tight casing in which is disposed at least one hollow cylindrical filter bellows, which sealingly separates a liquid inlet from a liquid outlet, and said casing having at least one support for supporting a radial outer contour of the filter bellows.

6. A filter element according to claim 5, wherein said at least one support comprises support contours distributed around the circumference of the casing such that the support contours both support the outer contour of the filter bellows against radially outwardly acting forces and transmit absorbed forces to the cup-shaped housing.

7. A filter element according to claim 6, wherein the support contours form discharge volumes that communicate with the bottom of the liquid-tight casing such that liquid filtered through the filter bellows can flow through said discharge volumes to a lowermost surface of the liquid-tight casing.

8. A filter element according to claim 5, wherein at least one active contour extending radially outwardly beyond the circumferential diameter of the liquid-tight casing is disposed in the vicinity of an axial end face of the filter element.

9. A filter element according to claim 8, wherein the active contour engages in a recess of the cup-shaped housing.

10. A filter element according to claim 5, further comprising an integral anti-drain membrane disposed adjacent the liquid inlet and outlet such that the anti-drain membrane closes the inlet and outlet to prevent egress of liquid from within the filter element when the filter element is removed from the housing.

11. A filter element according to claim 5, wherein two hollow cylindrical filter bellows are disposed concentrically in the interior of the liquid-tight casing such that the two filter bellows have a common end disk at one axial end face, and each filter bellows has a separate end disk at its opposite axial end face.

12. A filter element according to claim 11, wherein the common end disk on its side opposite the filter bellows has a spring member for supporting the end disk and bellows against an inside surface of said liquid-tight casing.

13. A filter element according to claim 11, wherein the separate end disk of the outer filter bellows simultaneously seals the liquid-tight casing, such that the radially outward rim of the end disk is non-releasably connected to the liquid-tight casing to form a seal.

14. A filter element according to claim 13, wherein the separate end disk has an annular collar extending axially away from the filter element, and a seal member is disposed in the annular collar to seal the filter element relative to the connection head.
